(19) United States
(12) Patent Application Publication
(10) Pub. No.: US 2021/0178571 A1
(43) Pub. Date: Jun. 17, 2021

(54) MAGNETIC BASE

(71) Applicant: C. & E. Fein GmbH, Schwaebisch Gmuend-Bargau (DE)

(72) Inventors: Sergej DENZEL, Schwaebisch Gmuend (DE); Stefan Scherrenbacher, Waldstetten (DE)

(73) Assignee: C. & E. Fein GmbH, Schwaebisch Gmuend-Bargau (DE)

(21) Appl. No.: 17/121,137

(22) Filed: Dec. 14, 2020

(30) Foreign Application Priority Data
Dec. 12, 2019 (DE) 20 2019 106 916.3

(51) Int. Cl. B25H 3/00; F16M 13/00

(52) U.S. Cl. CPC B25H 3/006; H01F 7/20; F16M 2200/08; F16M 13/005

(57) ABSTRACT

A magnetic base for an electric power tool, the magnetic base having a base body in which at least one first magnet is accommodated, whose magnetic force is switchable between a maximum resulting holding force and a minimum resulting holding force. A first side is adapted to be coupled with the electric power tool, and a second side is formed opposite the first side, the second side is adapted to be mounted on a workpiece to be processed. At least one wear indicator is arranged on the second side.

This nonprovisional application claims priority under 35 U.S.C. § 119(a) to German Patent Application No. 20 2019 106 916.3, which was filed in Germany on Dec. 12, 2019, and which is herein incorporated by reference.

### BACKGROUND OF THE INVENTION

### Field of the Invention

The present invention relates to a magnetic base for an electric power tool, in particular for a magnetic core drilling machine, comprising a base body, in which at least one first magnet is accommodated, whose magnetic force is switchable between a maximum resulting holding force and a minimum resulting holding force, the magnetic base having a first side, which may be coupled with the electric power tool, and an oppositely situated second side, which may be mounted on a workpiece to be processed.

### Description of the Background Art

Magnetic bases have already long been known from the prior art and are frequently used as part of a drill stand to fasten drilling machines, in particular core drilling machines, to the workpiece to be processed, with the aid of magnetic force. Electromagnets are customarily used for this purpose, which are also supplied with electrical energy via the voltage supply of the electric power tool coupled therewith, which has proven to be highly successful in the past. However, switchable permanent magnets are also used to meet customers' growing desire for battery-operated magnetic core drilling machines. A magnetic base of this type is known, for example, from US 2016/0001440 A1. In the case of these magnetic core drilling machines, a magnetic base comprising an electric magnet would prove to be disadvantageous, since the lifespan of the rechargeable batteries would be disadvantageously influenced.

In the case of magnetic bases used to fasten magnetic core drilling machines to the particular workpieces, there is, however, the problem that the holding force depends very much on the flatness of the surface which is in contact with the workpiece to be processed. If the position of the magnetic core drilling machine on the workpiece to be processed is to be changed, for example for fine adjustment as well as for relocating the magnetic core drilling machine between the drilling operations of individual holes, this does not take place, however, in that the magnetic core drilling machine is first removed from the workpiece and then set into the new position, but instead it is usually done by reducing the resulting magnetic force to the extent that the magnetic core drilling machine may be pushed manually by the user on the surface of the workpiece while still holding onto the workpiece.

With this displacement, however, there is then the problem that the underside of the magnetic bases becomes abraded or scratched and damaged due to friction, since chips often end up here between the workpiece and the magnetic base. This friction or this scratching, however, gives rise to the problem that local air gaps occur hereby between the workpiece and the magnetic base, whereby the value of the resulting maximum magnetic force is significantly reduced. This then results in the fact that the user may no longer be able to use the magnetic core drilling machine safely and must send it to the manufacturer for servicing. However, it is often difficult for the user to detect whether the resulting holding force is still sufficient to safely use the magnetic core drilling machine, or whether the magnetic core drilling machine must be subjected to maintenance.

### SUMMARY OF THE INVENTION

It is therefore an object of the present invention to provide a magnetic base which reduces the aforementioned disadvantages.

This object is achieved according to an exemplary embodiment of the invention in a magnetic base in that at least one wear indicator is assigned to a second side.

This makes it easier for the user of the magnetic base according to the invention to detect the wear on the side of the magnetic base in contact with the workpiece and thus to recognize the need to carry out service on the magnetic base or the magnetic core drilling machine and/or to replace the magnetic base.

It has also proven to be advantageous if the at least one wear indicator is provided multiple times. The wear is not only monitored locally hereby at one point, but it is also possible to monitor it at multiple points, whereby the abrasion or wear may be more easily monitored. In this connection, it has also proven to be particularly successful if the number of wear indicators is advantageously 2 or more, preferably 4 or more and particularly preferably 6 or more and further advantageously 14 or fewer, preferably 12 or fewer and particularly preferably 10 or fewer and exceptionally preferably 8.

It has also proven to be advantageous if the at least one wear indicator has a wear resistance, which is equal to or less than the wear resistance on the side of the magnetic base which may be placed on the workpiece. This ensures that the material of the magnetic base which surrounds the wear indicator becomes worn at the same rate as the wear indicator itself. In other words, this means that it is ultimately achieved thereby that the wear indicator is abraded at least to the same degree as the magnetic base itself, so that the user may clearly detect whether the magnetic base may continue to be used or must be provided for servicing.

The manufacturing complexity may be reduced, in particular, if the at least one wear indicator is designed as an indentation. This indentation may be particularly easily worked into the magnetic base, for example with the aid of a machining process. Due to the indentation, the user is also provided with an easy way to assess the wear, since the depth of the indentation decreases as the wear increases. Once the wear indicator is no longer detectable to the user, this is the sign for the user to replace the magnetic base. To further reduce the danger of chips entering the wear indicator, it has also proven to be successful in this connection if the indentation is cast. This may take place, for example with the aid of a metal which has a different color or, for example, also with the aid of plastic or a resin. In particular, a planar surface in the initial state is created hereby. If the wear indicator formed as an indentation is contrasted by color with the surrounding magnetic base by filling it in, this gives the user an easy way to identify the degree of wear.

It has also proven to be particularly advantageous if the shape of the wear indicators is selected from a group comprising rings, lines, circular areas and ellipses. In particular, these shapes may be particularly easily manufactured, whereby the manufacturing costs may be further reduced. The shapes may also be combined with each other.

It has furthermore proven to be successful if the at least one wear indicator is arranged in the edge region of the magnetic base. Since the edge regions of the magnetic base, in particular, are subject to heavy wear due to the manual displacement of the magnetic core drilling machine, a good possibility is provided hereby to detect the wear locally at the points where the wear occurs. In this connection, it is provided, in particular, according to the invention, that the distance of the wear indicator from the edge of the magnetic base is between 5% and 10% of the length of the magnetic base. An edge is understood to be a side edge of the magnetic base delimiting the magnetic base.

It has also been proven to be favorable if the at least one wear indicator is formed on a wear plate which is detachably fastened to the base body. This makes it possible to replace only the wear plate when a magnetic base becomes worn, whereby the service work and costs for the user are significantly reduced. In the past, the complete magnetic base always had to be replaced when the surface of the magnetic base became worn. This also results in the advantage that the magnetic base may be adapted to different workpiece contours. Within the scope of the invention, however, it is also provided to design the wear plate without wear indicators.

The servicing may also be reduced in that the wear plate is screwed to the base body, it having also been proven successful in this connection if the screwing takes place from the first side of the magnetic base. This ensures that the screwing of the wear plate takes place from the side which is not in contact with the workpiece to be processed. This achieves the fact that the holes for accommodating the screws, with which the wear plate is fastened to the magnetic base, may not become clogged with chips. Within the scope of the invention, it is, however, also provided that the screwing takes place from the side which is in contact with the workpiece or from a side surface of the magnetic base oriented perpendicularly with this side. As a result, it is then possible, in particular, to more easily adapt the wear plate to different geometries of workpieces.

It has also proven to be favorable if a side of the wear plate facing away from the base body has an essentially planar surface. This results in the fact that the magnetic base rests well on a flat workpiece, for example a metal carrier, and the danger of air gaps between the workpiece and the magnetic base is reduced thereby, which has a positive effect on the operating safety of the magnetic base. Alternatively, it is also provided within the scope of the invention that a groove is formed in the side of the wear plate facing away from the base body. This allows the magnetic base to be also used on workpieces which are not planar, for example on tubes or the like.

It has also proven to be particularly advantageous if the groove has a prismatic shape. A precise reproduction of the contour of the non-planar workpiece may be dispensed with hereby. Within the scope of the invention, however, it is also particularly preferred of the groove has a concave shape.

In this connection, is has furthermore proven to be favorable if the groove is oriented symmetrically with respect to a longitudinal axis of the base body. This maximizes the surface which comes into contact with the workpiece, which has an advantageous effect on the value of the maximum effective holding force.

It has also proven to be successful if the at least one wear indicator is formed as a sensor element, which is accommodated in the magnetic base. The wear on the magnetic base may be monitored hereby, and a signal may be output to the user if the wear reaches a wear limit. The sensor element may be designed, for example, in such a way that it generates a sensor signal, which is then evaluated in the magnetic base or in a magnetic core drilling machine connected to the magnetic base, only if a wear limit value is not reached. Alternatively, the gradual course of the wear may be detected by the sensor element. This gives the user the possibility of continuously detecting the wear.

In this connection, it has furthermore proven to be favorable if a shutoff device is provided, which deactivates the electric power tool upon exceeding a predefinable wear limit. This ensures that the electric power tool connected to the magnetic base according to the invention may be used only if the wear on the magnetic base is below a wear limit.

An electric power tool comprising a magnetic base is also provided.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective view from below of a first specific embodiment of a magnetic base;

FIG. 2 shows a perspective view from below of a second specific embodiment of a magnetic base, including a wear plate;

FIG. 3 shows a perspective view from below of a third specific embodiment of a magnetic base, including a groove;

FIG. 4 shows a detailed view of a first variant of the wear indicators;

FIG. 5 shows a detailed view of a second variant of the wear indicators;

FIG. 6 shows a detailed view of a third variant of the wear indicators;

FIG. 7 shows a detailed view of a fourth variant of the wear indicators;

FIG. 8 shows a detailed view of a fifth variant of the wear indicators; and

FIG. 9 shows a sectional view along a cross-section of a further specific embodiment of the magnetic base.

### DETAILED DESCRIPTION

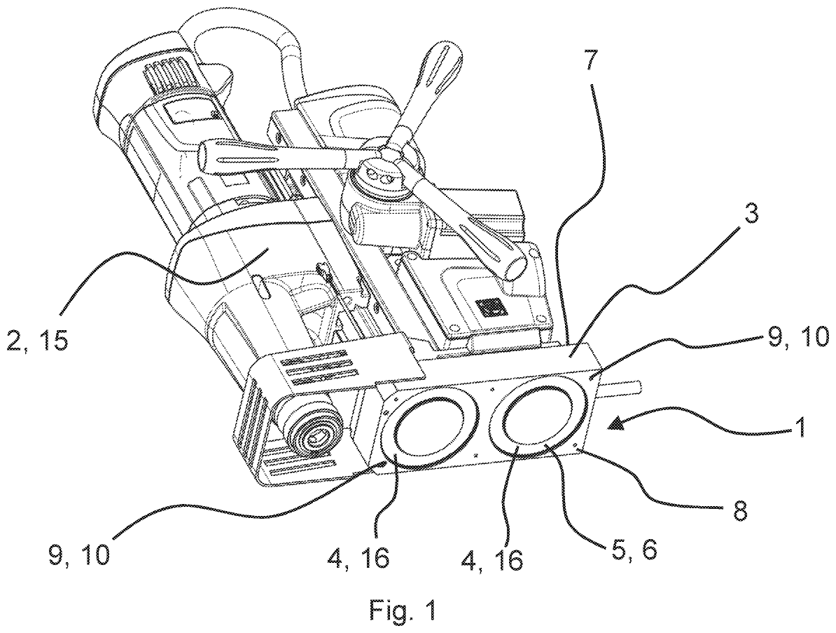

FIG. 1 shows a perspective view from below of a first specific embodiment of a magnetic base 1, which is fastened to an electric power tool 15, namely to a magnetic core drilling machine 2. Magnetic base 1 comprises a base body 3, in which, in the illustrated exemplary embodiment, two magnets 16 are accommodated, which are designed as solenoid coils 4 and which each form an electric magnet. Due to the applied voltage, the magnetic force thereof may be switched between a maximum resulting holding force and a minimum resulting holding force. Solenoid coils 4 are each in an annular recess 5, which is formed in base body 3, and cast with a casting compound 6. Magnetic base 1 has a first side 7, which is coupled with magnetic core drilling machine 2, and an oppositely situated second side 8, which may be placed on a workpiece to be processed. Multiple wear indicators 9, which indicate the wear on magnetic base 1, are formed on this second side 8. In the illustrated exemplary embodiment, the number of these wear indicators 9 is exactly 6. Within the scope of the invention, however, the number is advantageously 2 or more, preferably 4 or more and particularly preferably 6 or more and further advantageously 14 or fewer, preferably 12 or fewer and particularly preferably 10 or fewer and exceptionally preferably 8. Wear indicators 9 are formed as indentations 10 and have a circular shape. To prevent a penetration of chips into wear indicators 9, indentations 10 are cast. The material used for the casting has a wear resistance which is equal to or less than the wear resistance of second side 8 of magnetic base 1, which may be placed on the workpiece. This then achieves the fact that the wear on wear indicators 9 is at least as great as the wear on second side 8 of magnetic base 1, which is placed on the workpiece to be processed. As is further apparent from FIG. 1, wear indicators 9 are arranged in the edge region of magnetic base 1. since according to experience the wear is the greatest in this region. In the illustrated exemplary embodiment, the distance of wear indicators 9 from the edge of the magnetic base is approximately 5% of the length of magnetic base 1. If the user now determines that wear indicators 9 have worn down, he must subsequently present magnetic base 1 or entire magnetic core drilling machine 2 for servicing.

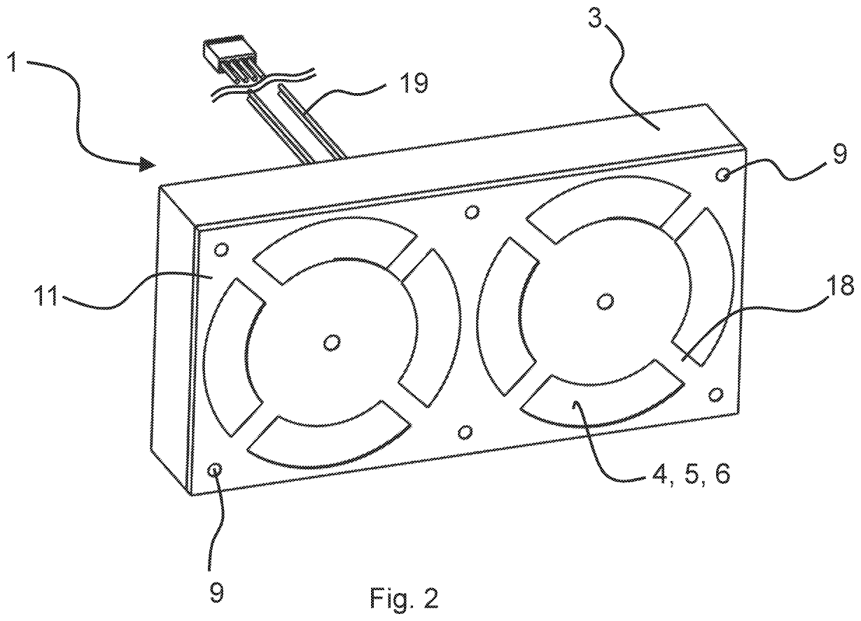

FIG. 2 also shows a perspective view from below of a second specific embodiment of magnetic base 1 according to the invention. In this specific embodiment, the total of eight wear indicators 9 are formed in a wear plate 11, which is detachably screwed to base body 3. The screwing takes place from first side 7 of magnetic base 1, i.e. from the side on which magnetic core drilling machine 2 is fastenable. The side of wear plate 11 facing away from base body 3 has an essentially planar surface and is therefore particularly suitable for fastening magnetic base 1 to an equally planar workpiece. Wear plate 11 is designed in such a way that recesses 5 accommodating solenoid coils 4. which are cast with casting compound 6, are partially covered by webs 18. It is furthermore apparent from FIG. 2 that an electric plug connector 19, illustrated in an interrupted manner, is formed on first side 7 of magnetic base 1, with the aid of which it is possible to couple the magnetic base with the controller of a magnetic core drilling machine 2.

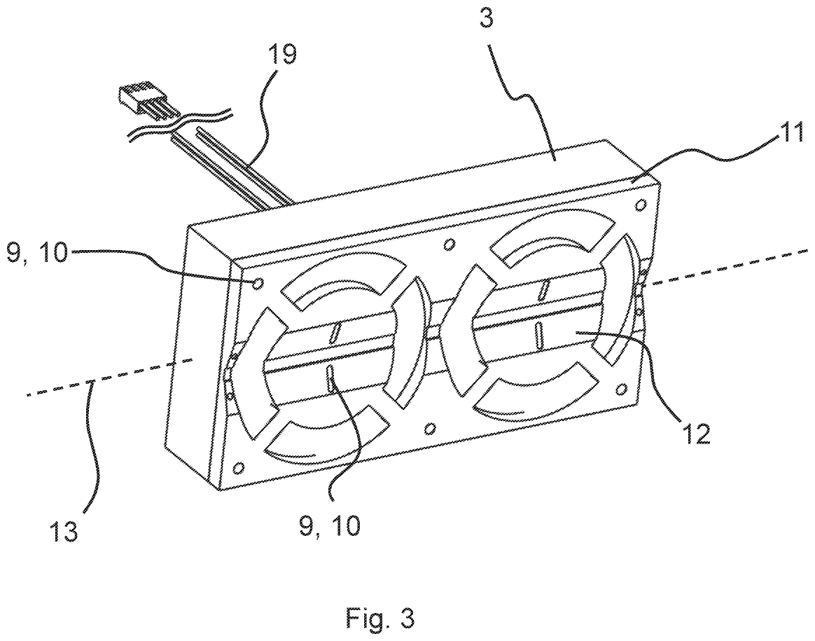

In the perspective view from below of the third specific embodiment of magnetic base 1 illustrated in FIG. 3, it is apparent that, in this example as well, wear indicators 9 are mounted on a wear plate 11 screwed to base body 3. In this specific embodiment, a groove 12 is formed in the side of wear plate 11 facing away from base body 3. In the illustrated exemplary embodiment, this groove 12 has a prismatic shape, which makes it possible to fasten magnetic base 1 to workpieces which do not have a planar surface, for example to pipes. Wear indicators 9 are also formed within this groove 12. This groove 12 is oriented symmetrically to a longitudinal axis 13 of base body 3. Due to the ability to screw wear plate 11, it is possible for the user to adapt magnetic base 1 to different surface contours.

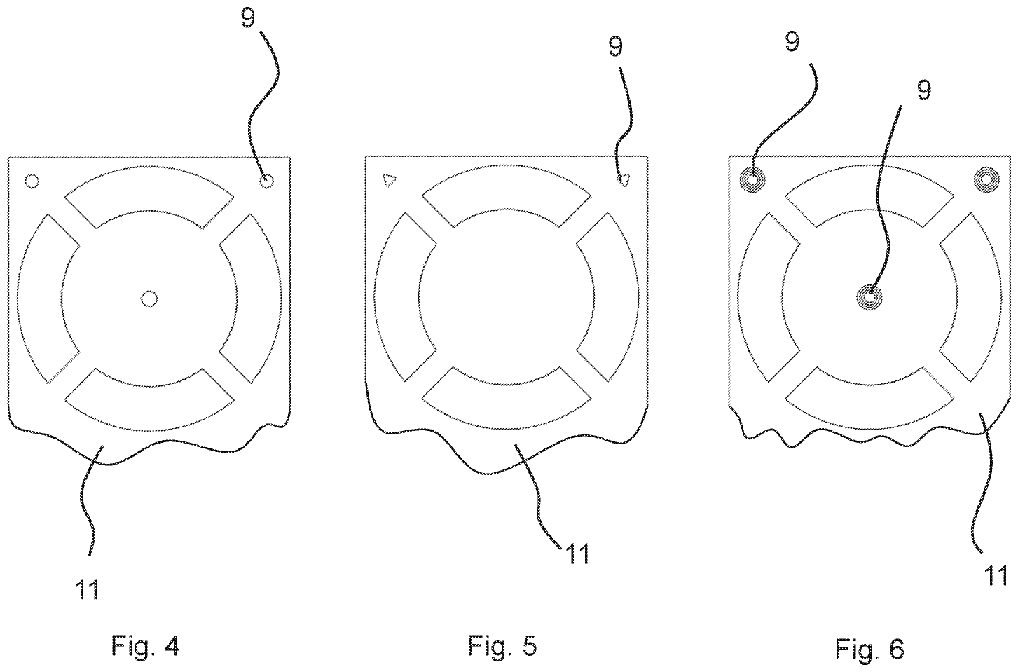

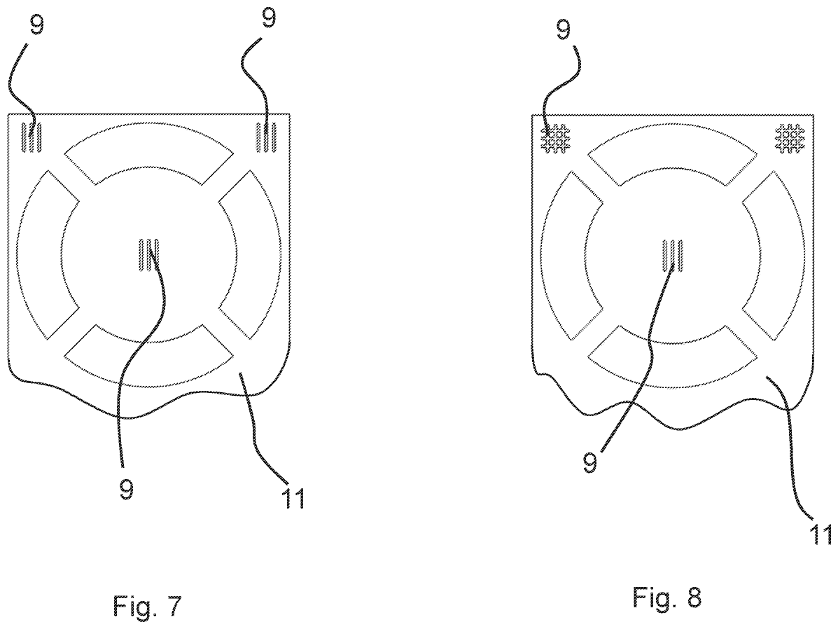

FIGS. 4 through 8 show detailed views of different shapes of wear indicators 9. which differ from each other with respect to their design. Wear indicators 9 illustrated in FIG. 4 have a circular disk-shaped design, while wear indicators 9 illustrated in FIG. 5 each have a triangular shape. Wear indicators 9 illustrated in FIG. 6, on the other hand, are each formed from concentric rings having different radii. Wear indicators 9 used in FIG. 7 are each multiple parallel lines, while wear indicators 9 in the specific embodiment according to FIG. 8 are finally designed as lines arranged perpendicularly with respect to each other.

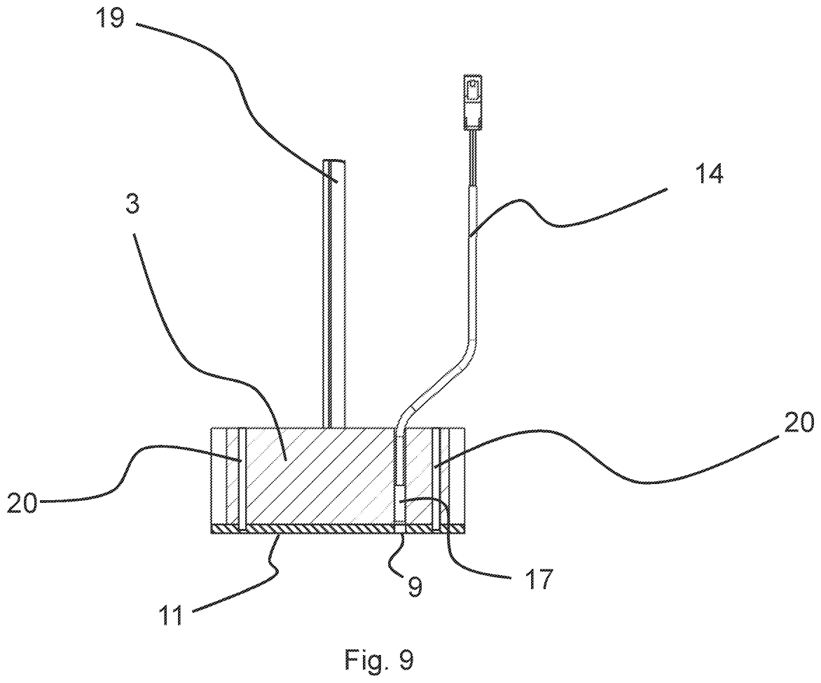

FIG. 9 shows a sectional view of a cross-section of magnetic base 1. This sectional view shows, in particular, that at least one of wear indicators 9 in the illustrated exemplary embodiment is formed as a sensor element 14. The latter is inserted from second side 8 into a corresponding receptacle 17 in base body 3 of magnetic base 1. If a predefined wear limit is exceeded, this makes it possible to deactivate magnetic core drilling machine 2 with the aid of a shutoff device, which is connected to the controller of magnetic core drilling machine 2. Receptacle 17 is closed by wear plate 11 from second side 8 of base body 3. Screw receptacles 20 are also apparent in FIG. 9, win which screws may be accommodated for the purpose of screwing base body 3 to wear plate 11.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A magnetic base for an electric power tool, the magnetic base comprising:
a base body in which at least one first magnet is accommodated, whose magnetic force is switchable between a maximum resulting holding force and a minimum resulting holding force;
a first side, which is adapted to be coupled with the electric power tool; and
a second side opposite the first side, the second side being adapted to be mounted on a workpiece to be processed; and
at least one wear indicator arranged on the second side.

2. The magnetic base according to claim 1, wherein the at least one wear indicator is provided multiple times.

3. The magnetic base according to claim 1, wherein the number of wear indicators is 2 or more, 4 or more or 6 or more, and 14 or fewer, 12 or fewer, 10 or fewer or 8.

4. The magnetic base according to claim 1, wherein the at least one wear indicator has a wear resistance which is equal to or less than the wear resistance of the second side of the magnetic base, which may be placed on the workpiece.

5. The magnetic base according to claim 1, wherein the at least one wear indicator is designed as an indentation.

6. The magnetic base according to claim 5, wherein the indentation is cast.

7. The magnetic base according to claim 1, wherein a shape of the wear indicator is a ring, a line, a circular area, and/or an ellipse.

8. The magnetic base according to claim 1, wherein the at least one wear indicator is arranged in an edge region of the magnetic base.

9. The magnetic base according to claim 1, wherein the at least one wear indicator is formed on a wear plate, which is detachably fastened to the base body.

10. The magnetic base according to claim 9, wherein the wear plate is screwed to the base body.

11. The magnetic base according to claim 10, wherein the screwing takes place from the first side of the magnetic base.

12. The magnetic base according to claim 9, wherein a side of the wear plate facing away from the base body has an essentially planar surface.

13. The magnetic base according to claim 9, wherein a groove is formed in the side of the wear plate facing away from the base body.

14. The magnetic base according to claim 13, wherein the groove has a prismatic shape.

15. The magnetic base according to claim 13, wherein the groove is oriented symmetrically to a longitudinal axis of the base body.

16. The magnetic base according to claim 1, wherein the at least one wear indicator is formed as a sensor element, which is accommodated in the magnetic base.

17. The magnetic base according to claim 16, wherein a shutoff device is provided, which deactivates the electric power tool if a predefined wear limit is exceeded.

18. An electric power tool comprising a magnetic base according to claim 1.

19. The magnetic base according to claim 1, wherein the electric power tool is a magnetic core drilling machine.
